(19) United States
(12) Patent Application Publication
(10) Pub. No.: US 2017/0316074 A1
(43) Pub. Date: Nov. 2, 2017

(54) DOCUMENT SYNCING

(71) Applicant: PEKAMA LTD., Cambridge (GB)

(72) Inventor: Zeev Fisher, Cambridge (GB)

(21) Appl. No.: 15/484,021

(22) Filed: Apr. 10, 2017

(30) Foreign Application Priority Data
Apr. 10, 2016 (GB) 1606056.8

(51) Int. Cl. G06F 17/30

(52) U.S. Cl. CPC G06F 17/30578; G06F 17/30011; G06F 17/30339

(57) ABSTRACT

A team-centric computerized document management system includes at least one data record, one or more collaboration spaces associated with said data record, for each collaboration space, one or more teams having access to said collaboration space, where each team has one or more users associated with it, an access permissions data module, holding data on access permissions, where the access permissions between users within teams are identical, such that when a particular user in the team may access a particular data record or collaboration space, other users in the team may access the exact same information, a document data module, holding meta data on documents, where each document is associated with a particular collaboration space and each document has permission definitions, and a document synchronization module, operable when a team elects or is being dictated a document management system. The documents in the document synchronization module are synchronized regularly between the information held in the document data and the document management systems that the team had elected or had been dictated.

### BACKGROUND

Technology in recent years have been used to create more efficient ways for teams to work on various matters.

One of the rapidly developing field is collaborative tools in the cloud and in smartphone apps.

However, these tools suffer from major drawbacks preventing them from being widely adopted in the services industry.

One of these drawbacks is the fact that each customer may choose a different document management system (also called a data storage), and this creates friction and lack of consistency. For example, one customer may choose to store files in Box.com® and another in Dropbox® or Google Drive®. This means that to properly collaborate, one side of the transaction will need to work with a different system.

A multi-side sync system is therefore presented, allowing each user to work on its own cloud storage of choice whilst seamlessly syncing this with users in other teams that chose different solutions.

### SUMMARY

According to one embodiment of this invention, a team-centric computerized access control system is proposed, comprising:
At least one data record;
One or more collaboration spaces associated with said data record;
For each collaboration space, one or more teams having access to said collaboration space, wherein each team has one or more users associated with it;
An access permissions data module, holding data on access permissions, wherein the access permissions between users within teams are identical, such that when a particular user in the team may access a particular data record or collaboration space, other users in the team may access the exact same information; and
A document data module, holding meta data on documents, wherein each document is associated with a particular collaboration space and wherein each document has permission definitions;
A document synchronization module, operable when a team elects or is being dictated a document management system;
Wherein the documents in the document synchronizations module are synchronized regularly between the information held in the document data and the document management systems that the team had elected or had been dictated.

According to another embodiment, the system further comprises a document repository, holding actual copies of the documents that are being synced in a location that is not owned by any of the teams collaborating in relation to a data record;

According to yet another embodiment, the system further comprises a contextualization module, for presenting the data associated with the collaboration space in its context.

According to yet another embodiment, the contextualization module is a time-line that provides a contextual indication to help the user decide which date range to present;

This invention also includes a method for synchronizing documents within a collaboration system, comprising the following steps:
Holding information on collaboration spaces, for each collaboration space, holding information on access permissions;
Holding meta data on documents, identifying teams that may access these documents, and the access level for each team for each document;
Holding team settings in relation to the document management system/s used by each team;
Identifying changes to documents on either the meta data associated to the documents or on the document management systems;
Constantly synchronizing said changes between all document management systems that have access to all the relevant collaboration spaces;

According to another embodiment, the method further comprises the step of:
Periodically notifying users who are followers of items within the collaboration space of changes and additions to the collaboration space.

According to an additional embodiment, A team-centric document management sync solution is proposed, comprising:
A document data module, holding meta data on documents, wherein each document is associated with a particular collaboration space and wherein each document has permission definitions;
A document synchronization module, synchronizing said meta data with the one or more document storage repositories;
Wherein the permissions to documents may be divided between more than one user or team;

According to yet another embodiment, the system further comprises a document repository, holding actual copies of the documents that are being synced in a neutral location.

### BRIEF DESCRIPTION OF DRAWINGS

FIG. 1 is a diagram showing a team-centric document management sync solution, according to an embodiment of the present invention.

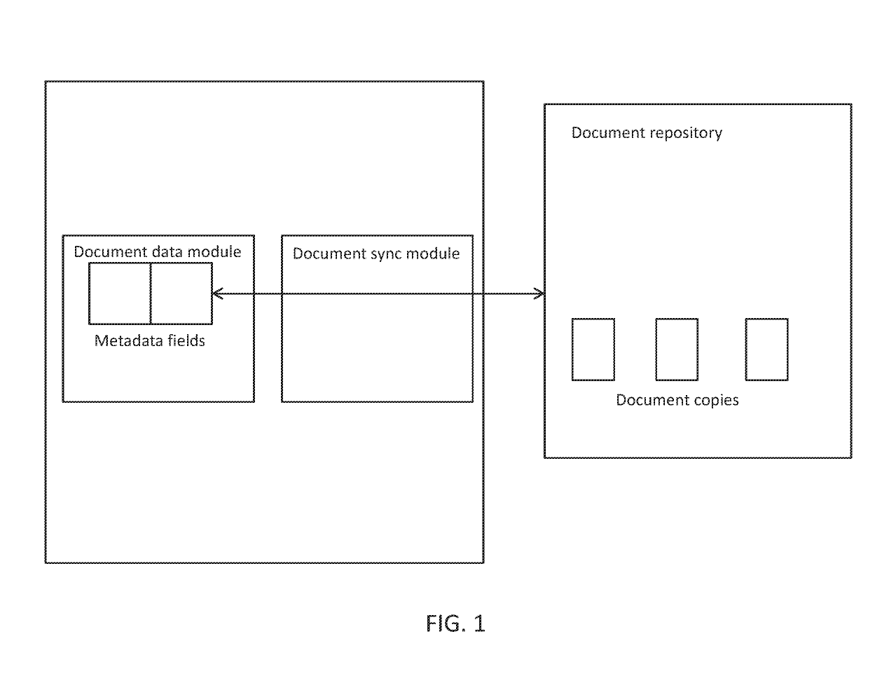

FIG. 2 is a flowchart illustrating a method for synchronizing documents within a collaboration system, according to an embodiment of the present invention.

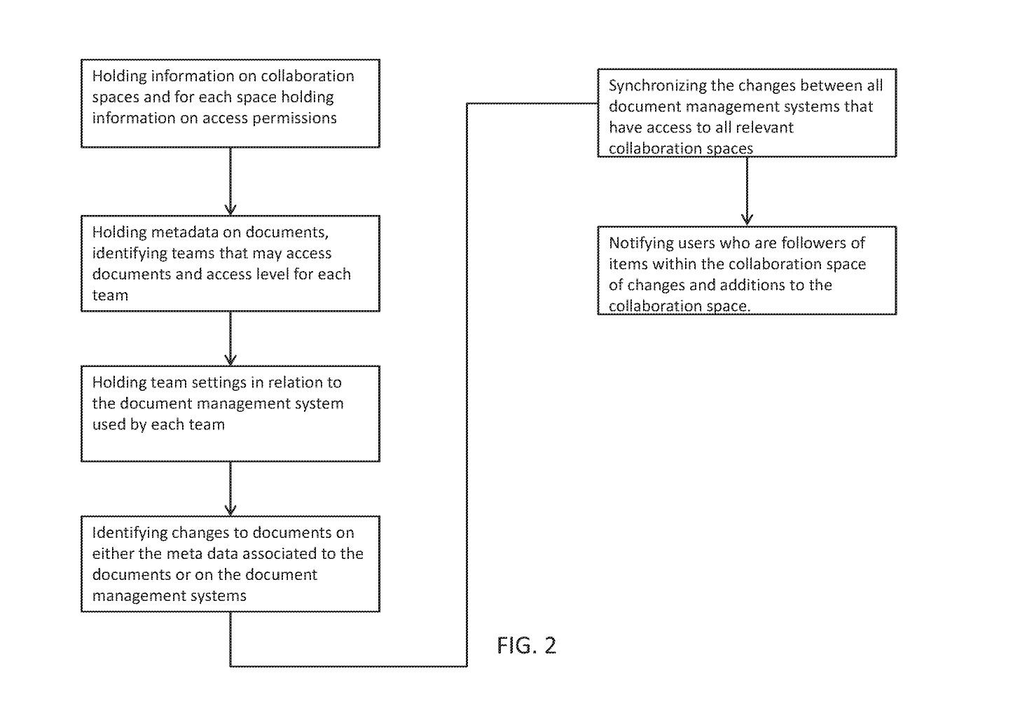

FIG. 3 is a diagram showing a team-centric computerized document management system, according to an embodiment of the present invention.

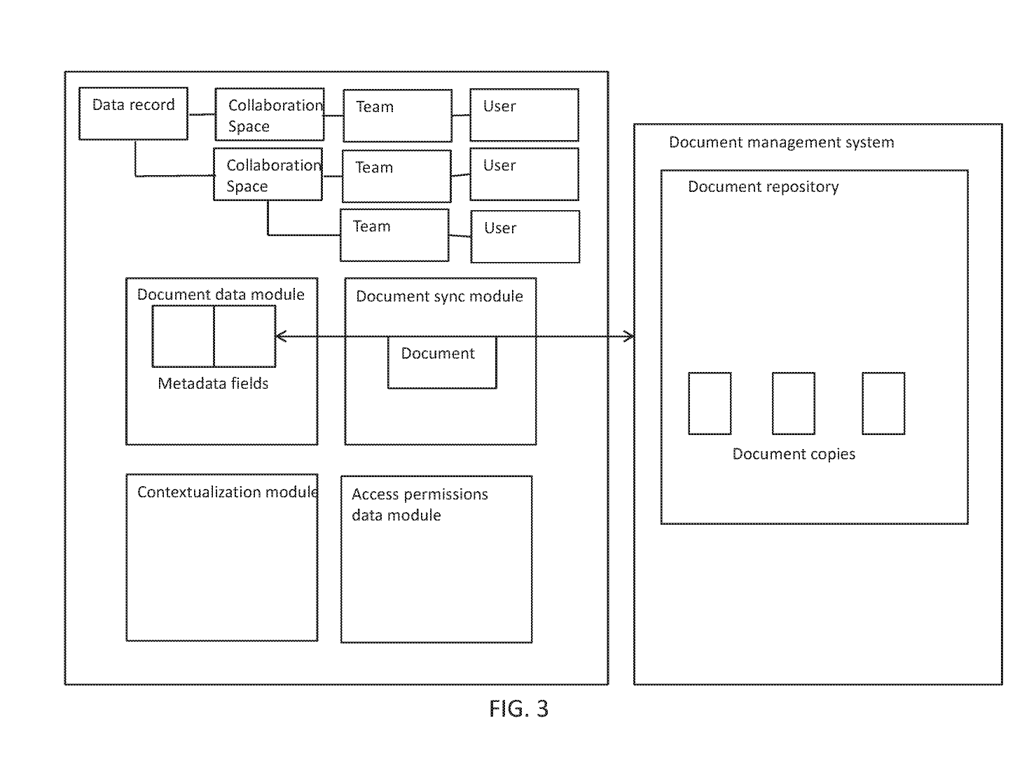

### DESCRIPTION

Tools for facilitating collaborative work are becoming more and more common. These tools, however, are not benefiting the services industry and are rarely adopted.

The main reason for this is that these tools can be roughly divided into tools for collaboration within teams and tools for collaboration between individuals.

Services, however, require collaboration between multiple teams. For example, for the delivery of a legal service, a law firm needs to share access permissions and work with a client which is often a company and that also needs to share access permission. This type of collaboration between teams is not properly handled by existing systems.

Another issue preventing the wide adoption of cloud collaboration tools is the diversity of such tools in the market. One of the major areas of competition is document storage/repositories. There are a number of grand players within this market, such as Dropbox®, Microsoft® (OneDrive®), Google® (Google Drive®), Box.com® and others.

To collaborate well, users must agree on a single storage solution. This is not particularly difficult when working in a single team where a team manager can dictate a solution, but when working between multiple teams, it is nearly impossible. Each team is already used to a particular solution of choice and often reluctant to install and use a different one. Permission management is also tricky, as the team that created a particular matter enjoys a nice and handy folder structure on its document repository but the team that a folder had been shared with will see the folder on its root folder. This makes large-scale collaboration between teams incredibly clunky.

The proposed system solves this problem by creating a central repository of documents and documents meta-data (and in a different embodiment, only meta-data), and controls the permissions to these documents centrally.

Then, each team that participates in the collaboration may sync the central repository with its own cloud (or in premise, or private cloud) storage solution of choice, or even with a number of them. This means that John can use DropBox and Jane, a member of a different team, can use OneDrive, and the documents on each of their storage services will be seamlessly synced to the central repository.

This also means that both John and Jane will enjoy a clear folder structure that is fully supported in its storage system of choice.

Furthermore, some users may have a legacy storage system that they wish to replace. A sync solution that will allow them to work on a new storage solution or on the old one can allow for seamless transition even within the same team.

1. A team-centric computerized document management system, comprising:
At least one data record;
One or more collaboration spaces associated with said data record;
For each collaboration space, one or more teams having access to said collaboration space, wherein each team has one or more users associated with it;
An access permissions data module, holding data on access permissions, wherein the access permissions between users within teams are identical, such that when a particular user in the team may access a particular data record or collaboration space, other users in the team may access the exact same information; and
A document data module, holding meta data on documents, wherein each document is associated with a particular collaboration space and wherein each document has permission definitions;
A document synchronization module, operable when a team elects or is being dictated a document management system;
Wherein the documents in the document synchronizations module are synchronized regularly between the information held in the document data and the document management systems that the team had elected or had been dictated.

2. The system of claim 1, further comprising a document repository, holding actual copies of the documents that are being synced in a location that is not owned by any of the teams collaborating in relation to a data record;

3. The system of claim 1, further comprising a contextualization module, for presenting the data associated with the collaboration space in its context.

4. The system of claim 3, wherein the contextualization module is a time-line that provides a contextual indication to help the user decide which date range to present;

5. A method for synchronizing documents within a collaboration system, comprising the following steps:
Holding information on collaboration spaces, for each collaboration space, holding information on access permissions;
Holding meta data on documents, identifying teams that may access these documents, and the access level for each team for each document;
Holding team settings in relation to the document management system/s used by each team;
Identifying changes to documents on either the meta data associated to the documents or on the document management systems;
Constantly synchronizing said changes between all document management systems that have access to all the relevant collaboration spaces;

6. The method of claim 5, further comprising the step of:
Periodically notifying users who are followers of items within the collaboration space of changes and additions to the collaboration space.

7. A team-centric document management sync solution, comprising:
A document data module, holding meta data on documents, wherein each document is associated with a particular collaboration space and wherein each document has permission definitions;
A document synchronization module, synchronizing said meta data with the one or more document storage repositories;
Wherein the permissions to documents may be divided between more than one user or team;

8. The system of claim 7, further comprising a document repository, holding actual copies of the documents that are being synced in a neutral location;
